(19) United States
(12) Patent Application Publication
(10) Pub. No.: US 2010/0136409 A1
(43) Pub. Date: Jun. 3, 2010

(54) Battery cell with a partial dielectric barrier for improved battery pack mechanical and thermal performance

(75) Inventors: Jeffrey Brian Straubel, Menlo Park, CA (US); Eugene Michael Berdichevsky, Redwood City, CA (US); David Frederick Lyons, Palo Alto, CA (US); Robert Ferber, Woodside, CA (US)

Correspondence Address: PATENT LAW OFFICE OF DAVID G. BECK, P. O. BOX 1146, MILL VALLEY, CA, 94942, US

(73) Assignee: Tesla Motors, Inc., San Carlos, CA (US)

(21) Appl. No.: 12/383,871

(22) Filed: Mar. 30, 2009

Related U.S. Application Data
(60) Provisional application No. 61/206,586, filed on Jan. 31, 2009.

(51) Int. Cl. H01M 2/14

(52) U.S. Cl. 429/129

(57) ABSTRACT

The adverse effects of the dielectric material covering the cylindrical case of a conventional 18650 cell are eliminated by replacing it with a ring-shaped dielectric material, wherein the ring-shaped dielectric material does not extend down or otherwise cover the cylindrical outer surface of the cell's casing. The ring-shaped dielectric material provides access to the battery terminal corresponding to the cap assembly while preventing shorting between the battery terminal and the edge of the cell casing.

### CROSS-REFERENCE TO RELATED APPLICATION

This application claims the benefit of the filing date of U.S. Provisional Patent Application Ser. No. 61/206,586, filed Jan. 31, 2009, the disclosure of which is incorporated herein by reference for any and all purposes.

### FIELD OF THE INVENTION

The present invention relates generally to battery cells and, more particularly, to a method and apparatus for improving the mechanical and thermal performance of the individual battery cells that are integrated within a battery pack.

### BACKGROUND OF THE INVENTION

Battery packs, also referred to as battery modules, have been used for years in a variety of industries and technologies that include everything from portable electric tools and laptop computers to small hand-held electronic devices such as cell phones, MP3 players, and GPS units. In general, a battery pack is comprised of multiple individual batteries, also referred to as cells, contained within a single or multi-piece housing. Single piece housings are often comprised of shrink-wrap while multi-piece housings often rely on a pair of complementary housing members that are designed to fit tightly around the cells when the housing members are snapped or otherwise held together. Typically a conventional battery pack will also include means to interconnect the individual cells as well as circuitry to enable charging and/or to protect against overcharging.

Recent advances in the development of hybrid and electric vehicles have lead to the need for a new type of battery pack, one capable of housing tens to hundreds to even thousands of individual cells. For example, the battery pack used in at least one version of the Roadster manufactured by Tesla Motors contains nearly 7000 individual Li-ion cells, the individual cells having the 18650 form-factor. In addition to requiring this new type of battery pack to house a large number of cells, it must be capable of surviving the inherent thermal and mechanical stresses of a car for a period of years while minimizing weight, as hybrids and electric cars are exceptionally sensitive to excess weight. Lastly, the design of a vehicle battery pack should lend itself to efficient, and preferably automated, manufacturing practices.

The fundamental building block of a battery pack is the individual cell. As such, each cell will preferably meet certain criteria, thereby enabling the fabrication of an efficient and reliable battery pack. First, the cell's design must lend itself to efficient thermal dissipation as each cell within the battery pack can generate significant heat during use and/or charging. Second, it must be capable of being securely mounted within the battery pack as movement of the individual cells within the battery pack can lead to shorting, cell damage, contact breakage, or other failure. Third, each cell should include some form of electrical insulation to minimize the risk of shorting during handling, installation and use. The present invention provides an improved cell design that achieves each of these goals.

### SUMMARY OF THE INVENTION

The present invention eliminates the adverse effects of the dielectric material covering the cylindrical case of a conventional 18650 cell by eliminating this covering and replacing it with a ring-shaped dielectric material, the ring-shaped dielectric material not extending down or otherwise covering the cylindrical outer surface of the cell's casing. Accordingly, the ring-shaped dielectric material provides access to the battery terminal while preventing shorting between the terminal and the edge of the cell casing. This design significantly improves cell heat transfer efficiency while providing a better surface, i.e., the bare cell casing, to which to bond, clamp, or otherwise attach to during cell integration within a battery pack or other package.

A further understanding of the nature and advantages of the present invention may be realized by reference to the remaining portions of the specification and the drawings.

### BRIEF DESCRIPTION OF THE DRAWINGS

FIG. 1 is a simplified cross-sectional illustration of a cell utilizing the 18650 form-factor;

FIG. 2 illustrates the conventional dielectric covering applied to the cell shown in FIG. 1;

FIG. 3 illustrates a minor modification of the dielectric covering shown in FIG. 2;

FIG. 4 illustrates a dielectric ring in accordance with the invention; and

FIG. 5 illustrates an end-view of the dielectric ring shown in FIG. 4.

### DESCRIPTION OF THE SPECIFIC EMBODIMENTS

In the following text, the terms “battery”, “cell”, and “battery cell” may be used interchangeably and may refer to any of a variety of different rechargeable cell chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration. The term “battery pack” as used herein refers to multiple individual batteries contained within a single piece or multi-piece housing, the individual batteries electrically interconnected to achieve the desired voltage and capacity for a particular application. It should be understood that identical element symbols used on multiple figures refer to the same component, or components of equal functionality. Additionally, the accompanying figures are only meant to illustrate, not limit, the scope of the invention and should not be considered to be to scale.

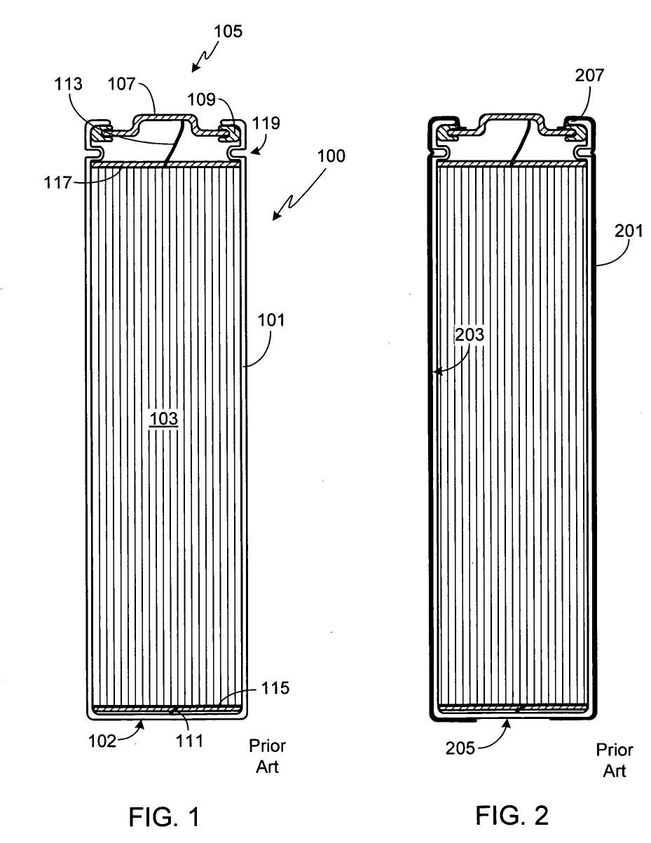

FIG. 1 is a simplified cross-sectional view of a battery 100, for example a lithium ion battery, utilizing the 18650 form-factor. Battery 100 includes a cylindrical case 101, an electrode assembly 103, and a cap assembly 105. Case 101 is typically made of a metal, such as nickel-plated steel, that has been selected such that it will not react with the battery materials, e.g., the electrolyte, electrode assembly, etc. For an 18650 cell, case 101 is often referred to as a can as it is comprised of a cylinder and an integrated, i.e., seamless, bottom surface 102. Cap assembly 105 includes a battery terminal 107, e.g., the positive terminal, and an insulator 109, insulator 109 preventing terminal 107 from making electrical contact with case 101. Cap assembly 105 typically also includes an internal positive temperature coefficient (PTC) current limiting device and a venting mechanism (neither shown), the venting mechanism designed to rupture at high pressures and provide a pathway for cell contents to escape. Cap assembly 105 may contain other seals and elements depending upon the selected design/configuration. Electrode assembly 103 is comprised of an anode sheet, a cathode sheet and an interposed separator, wound together in a spiral pattern often referred to as a ‘jelly-roll’. An anode electrode tab 111 connects the anode electrode of the wound electrode assembly to the negative terminal while a cathode tab 113 connects the cathode electrode of the wound electrode assembly to the positive terminal. In the illustrated embodiment, the negative terminal is case 101 and the positive terminal is terminal 107. In most configurations, battery 100 also includes a pair of insulators 115/117. Case 101 includes a crimped portion 119 that is designed to help hold the internal elements, e.g., seals, electrode assembly, etc., in place.

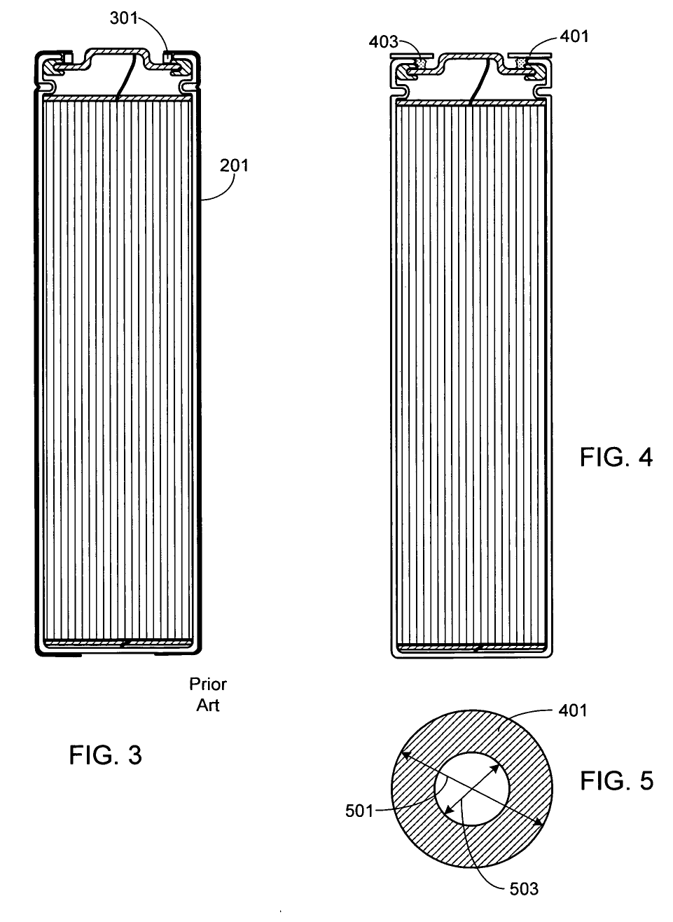

In a typical cell fabrication process, the last step is to surround case 101 with a dielectric material 201, as shown in FIG. 2. More specifically, material 201 covers the entire cylindrical lateral surface 203, a portion of bottom surface 205, and a portion of the cap assembly 105. In a conventional cell, dielectric material 201 is comprised of a shrink-wrap material, thus allowing a snug fit to be achieved and one in which it is unlikely that the material will slip out of place. The primary purpose of outer case covering 201 is to decrease the chances of inadvertently shorting the cell during normal handling and use, a possibility that is enhanced by the entire case 101 being connected to the anode and the proximity of positive terminal 107 to the edge portion 207 of case 101. Some battery manufacturers even add an additional layer 301 of insulating material between the battery casing and outer covering 201 as shown in FIG. 3, layer 301 helping to insure that edge portion 207 of case 101 is covered. Note that in a conventional cell, edge portion 207 is bent over as shown, at an approximately 90 degree angle from the cylindrical lateral wall of case 101, thereby holding cap assembly 105 in place.

Although the prior approach to covering case 101 serves its intended purpose, i.e., minimizing the risk of inadvertent shorting, the present inventors have found that such an approach has significant drawbacks relative to the fabrication of, and use within, large battery packs as required by certain applications, e.g., electric vehicles. The four primary areas adversely affected by dielectric covering 201 are efficient heat transfer, mechanical robustness, overall system energy efficiency, and cell tolerances.

Heat transfer—Battery cells, especially those utilizing advanced cell chemistries to achieve higher energy densities such as lithium ion and lithium ion polymer, generate significant heat during operation. Excessive heat not only leads to reduced battery life and performance, it can also pose a significant fire hazard. The problems associated with excessive heat generation are clearly exacerbated in large battery packs that may house hundreds or thousands of cells in close proximity to one another. To overcome the problems associated with excessive heat generation, it is imperative that this heat be efficiently removed from the battery pack, and thus the individual cells. Unfortunately, while dielectric cover 201 provides a safeguard against inadvertent shorting, its poor thermal conductivity significantly impacts the efficient removal of generated heat.

Mechanical robustness—In a large battery pack, i.e., one containing hundreds to thousands of cells, and especially in a battery pack contained within a vehicle where it is routinely subjected to vibrations and erratic shaking, it is critical that each cell remain in place, thus minimizing the risk of damage to the cells, cell interconnects, cooling conduits, mounting structures and associated battery electronics contained within the battery pack. The design of a conventional cell, however, does not lend itself to such an approach since in a conventional cell, the outer dielectric covering 201 is not bonded to the cell casing, rather it is simply shrink-wrapped into place. As such, bonding a conventional cell into a battery pack will lead to an insecure, and therefore inadequate, mechanical connection between the underlying cell casing and the rest of the battery pack.

Mass—In a conventional cell, the dielectric cover material 201 can have a mass of approximately a gram. Although this quantity is relatively inconsequential when viewed by itself, when multiplied by the thousands of cells contained within a large battery pack, this mass becomes significant.

Cell Tolerance—The thickness of dielectric cover material 201 can vary considerably, resulting in similar variations in the dimensions of a conventional cell to which it is applied. This, in turn, makes it difficult to maintain the tight tolerances desired in order to achieve tight packing density, efficient heat withdrawal and automated manufacturing processes.

To overcome the deficiencies of a conventional battery, the present invention eliminates dielectric material 201, leaving outer cylindrical surface 203 and bottom surface 205 bare and uncovered. According to the invention, dielectric material 201 is replaced with a small ring of dielectric material surrounding terminal 107. As shown in FIG. 4, the ring of dielectric material 401 is bonded to the top edge of casing 101 and preferably a portion of cap assembly 105 as well. Illustrated element 403 is a portion of the adhesive used to bond ring 401 to the cap assembly. It should be noted that ring 401 does not extend down the cylindrical side surface 203 of case 101. As ring 401 covers case edge 207, it prevents the most common source of battery shorting, i.e., inadvertent contact between case edge 207 and terminal 107.

FIG. 5 shows a top view of dielectric ring 401. Preferably the outer diameter 501 of ring 401 is between 90 percent and a 110 percent of the diameter of case 101; more preferably between 95 percent and a 105 percent of the diameter of case 101; and still more preferably within 2 percent of the diameter of case 101. Preferably the inner diameter 503 of ring 401 is within 25 percent of the diameter of battery terminal 107; more preferably within 15 percent of the diameter of battery terminal 107; and still more preferably within 10 percent of the diameter of case 101. According to the invention, dielectric ring 401 can be fabricated from any material providing low electrical conductivity. Although exemplary materials include synthetic polymers (e.g., nylon), synthetic fluoropolymers (e.g., Teflon), and polyimides (e.g., Kapton), it will be appreciated that the invention is not limited to these materials and can, in fact, use any of a variety of dielectric materials. In addition to being a dielectric, preferably the material used for ring 401 has a relatively high melting temperature, at least sufficient to withstand the expected temperature extremes associated with cell 100.

Although ring 401 prevents common shorting problems, it is small enough to have only an insignificant effect on heat transfer. In particular, ring 401 does not cover any portion of the side surface 203 of case 101. As surface 203 comprises 88 percent of the surface area of a battery utilizing the 18650 form-factor, elimination of the dielectric from this surface has a major impact on heat transfer efficiency. Additionally, as the present invention does not place any dielectric material over bottom surface 205, approximately another 2-4 percent of the cell's surface area is freed from dielectric material 201. Accordingly, by replacing dielectric cover 201 with dielectric ring 401, the present invention covers approximately 90 percent less cell surface than that achieved by a conventional cell. This leads to significant improvements in heat transfer efficiency that, in turn, provide improved cell and battery pack performance while reducing the risks associated with cell overheating.

In addition to significantly improving heat transfer efficiency, the present invention also dramatically improves battery mounting within the pack. Specifically, removal of the dielectric material 201 from the cell allows the cell mounting means, for example an adhesive bond, to be applied directly to the cell casing. As a result, a much more robust and secure mechanical connection is formed between the cell and the battery pack, leading to a more reliable battery pack even when subjected to the vibration-intense environment of a car.

Lastly, replacement of material cover 201 with dielectric ring 401 can significantly reduce the weight of the battery pack. For example, assuming a mere reduction of 1 gram per cell, in a 7,000 cell battery pack, a weight savings of 7 kilograms is achieved.

Although the preferred embodiment of the invention is utilized with a cell using the 18650 form-factor, it will be appreciated that the invention can be used with other cell designs and shapes.

As will be understood by those familiar with the art, the present invention may be embodied in other specific forms without departing from the spirit or essential characteristics thereof.

What is claimed is:

1. An 18650 cell, comprising:
a cell case comprised of a cylinder having a cylindrical outer surface, a first end and a second end, wherein said first end is closed by an integral case bottom and said second end is open, and wherein said cylindrical outer surface and an outer bottom surface corresponding to said integral case bottom are bare and uncovered;
an electrode assembly contained within said cell case, wherein a first electrode of said electrode assembly is electrically connected to said cell case;
a cap assembly mounted to said cell case, said cap assembly closing said second end, wherein said cap assembly further comprises a battery terminal electrically isolated from said cell case and electrically connected to a second electrode of said electrode assembly; and
a ring-shaped dielectric material bonded to an edge of said second end of said cell case and surrounding said battery terminal of said cap assembly, wherein said ring-shaped dielectric material does not extend down or otherwise cover said cylindrical outer surface of said cell case.

2. The 18650 cell of claim 1, wherein said dielectric material is comprised of a material selected from the group of materials consisting of synthetic polymers, synthetic fluoropolymers, and polyimides.

3. The 18650 cell of claim 1, wherein said ring-shaped dielectric material is bonded to a portion of said cap assembly.

4. The 18650 cell of claim 1, wherein an outer diameter of said ring-shaped dielectric material is within 10 percent of an outer diameter of said cell case.

5. The 18650 cell of claim 1, wherein an inner diameter of said ring-shaped dielectric material is within 10 percent of an outer diameter of said battery terminal of said cap assembly.

6. The 18650 cell of claim 1, wherein said first electrode is an anode and said second electrode is a cathode.
